(19) United States
(12) Patent Application Publication
(10) Pub. No.: US 2025/0209286 A1
(43) Pub. Date: Jun. 26, 2025

(54) RFID READER

(71) Applicant: QUALCOMM Incorporated, San Diego, CA (US)

(72) Inventors: Pranavsesh VS, Hyderabad (IN); Balasubramanian RAMACHANDRAN, Hyderabad (IN); Francesco GATTA, San Diego, CA (US); Joseph Patrick BURKE, Carlsbad, CA (US)

(21) Appl. No.: 18/390,684

(22) Filed: Dec. 20, 2023

(51) Int. Cl. G06K 7/10

(52) U.S. Cl. CPC G06K 7/10366

(57) ABSTRACT

An apparatus, including: a receive chain; a transmit chain configured to generate a continuous wave (CW) radio frequency (RF) signal; and a directional coupler circuit configured to couple the CW RF signal to an antenna, the directional coupler circuit being configurable to couple a received RF signal that is based on the CW RF signal from the antenna to the receive chain; the receive chain being configured to demodulate the received RF signal to recover RF identification (RFID) information from the received RF signal.

### FIELD

Aspects of the present disclosure relate generally to radio frequency identification (RFID), and more particularly, to RFID reader technology in a wireless communication user equipment.

### BACKGROUND

An RFID system may include a passive RFID tag and an RFID reader. The RFID reader may transmit a continuous wave (CW) radio frequency (RF) signal to activate (e.g., power up) the RFID tag. Once activated by the CW RF signal, the RFID tag may use a backscatter technique to send an information signal to the RFID reader (e.g., in response to a query from the RFID reader sent via the CW RF signal). Thus, the RFID reader may transmit CW RF signals to power up an RFID tag while concurrently receiving data sent by the RFID tag.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus includes: a receive chain; a transmit chain configured to generate a continuous wave (CW) radio frequency (RF) signal; and a directional coupler circuit configured to couple the CW RF signal to an antenna, the directional coupler circuit being configurable to couple a received RF signal that is based on the CW RF signal from the antenna to the receive chain; the receive chain being configured to demodulate the received RF signal to recover RF identification (RFID) information from the received RF signal.

Another aspect of the disclosure relates to a method. The method includes: generating a continuous wave (CW) radio frequency (RF) signal; coupling the CW RF signal to an antenna via a directional coupler circuit; configuring the directional coupler circuit to couple a received RF signal that is based on the CW RF signal from the antenna to a receive chain; and demodulating the received RF signal to recover RF identification (RFID) information from the received RF signal.

Another aspect of the disclosure relates to an apparatus. The apparatus includes means for generating a continuous wave (CW) radio frequency (RF) signal; directional coupler means for coupling the CW RF signal to an antenna; means for configuring the directional coupler means to couple a received RF signal that is based on the CW RF signal from the antenna to a means for receiving; and means for demodulating the received RF signal to recover RF identification (RFID) information from the received RF signal.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates an example wireless communication system in accordance with an aspect of the disclosure.

FIG. 2 illustrates an example RFID system in accordance with another aspect of the disclosure.

FIG. 3 illustrates an example RFID system including an apparatus that incorporates RFID reader circuitry in accordance with another aspect of the disclosure.

FIG. 4 illustrates an example of the RFID reader circuitry of the apparatus of FIG. 3 in accordance with another aspect of the disclosure.

FIG. 5 illustrates a block diagram of an example apparatus programmed to provide RFID reader functionality in accordance with another aspect of the disclosure.

FIG. 6 illustrates an example of circuitry for transmitting a continuous wave (CW) signal and for receiving a reflected backscattered signal and a component of the transmitted CW signal in accordance with another aspect of the disclosure.

FIG. 7A illustrates a block diagram of an example apparatus that provides RFID reader functionality in accordance with another aspect of the disclosure.

FIG. 7B illustrates an apparatus corresponding to the apparatus of FIG. 7A including additional wide area network (WAN) communication components in accordance with another aspect of the disclosure.

FIG. 8 illustrates a block diagram of an example user equipment in accordance with another aspect of the disclosure.

FIG. 9 illustrates a flow diagram of an example RFID method in accordance with another aspect of the disclosure.

FIG. 10 illustrates a flow diagram of another example RFID method in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various aspects of the disclosure relate to RFID communication. In some examples, a user equipment that is operable within a wireless communication system may include RFID reader functionality.

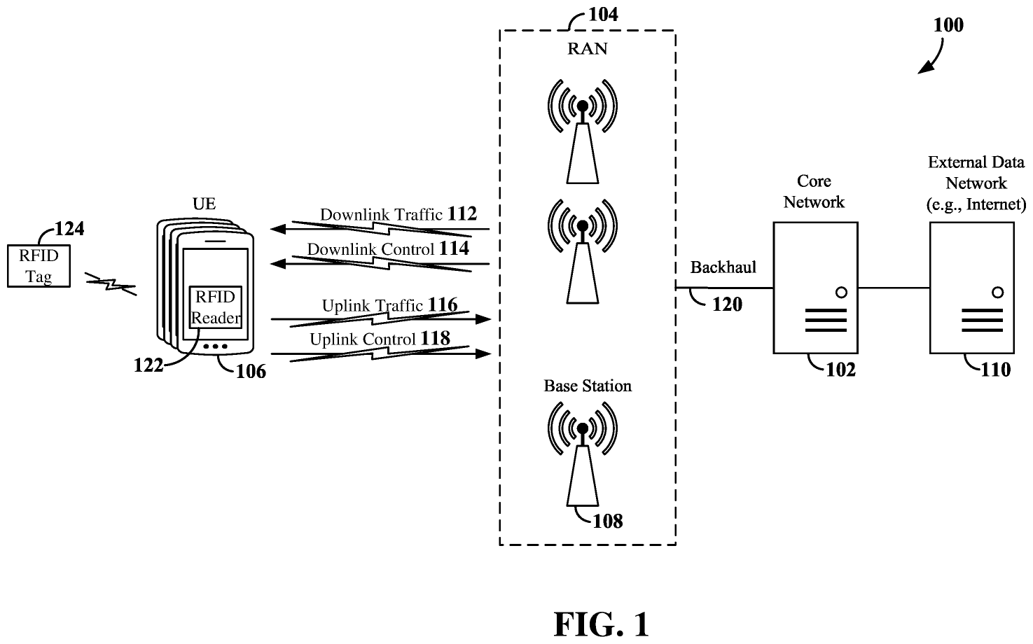

FIG. 1 illustrates an example wireless communication system 100 in accordance with an aspect of the disclosure. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

In addition, the UE 106 may include RFID reader functionality 122 that can receive RFID information from at least one RFID tag (e.g., RFID tag 124). To this end, the UE 106 may transmit a continuous wave (CW) radio frequency (RF) signal that can activate RFID circuitry on the RFID tag 124. In addition, the UE 106 may demodulate and decode backscatter signals from the RFID tag 124 to thereby recover RFID information modulated onto the backscatter signals by the RFID tag 124.

The RAN 104 may implement any suitable wireless communication technology or technologies to provide radio access to the UE 106. As one example, the RAN 104 may operate according to the European telecommunications standards institute (ETSI) global system for mobile communications (GSM) specifications. As another example, the RAN 104 may operate according to 3rd Generation Partnership Project (3GPP) New Radio (NR) specifications, often referred to as 5G. As a further example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a type of network entity in a radio access network that is responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), a disaggregated base station, or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 supports wireless communication for multiple UEs or other apparatuses. A UE may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The term UE broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A UE may additionally be incorporated into or include an automotive or other transportation vehicle, a remote sensor or actuator, a robot or robotics device, a satellite radio, a global positioning system (GPS) device, an object tracking device, a remote control device, a consumer and/or wearable device, such as eyewear, a wearable camera, a virtual reality device, a smart watch, a health or fitness tracker, a digital audio player (e.g., MP3 player), a camera, a game console, etc. A UE may additionally be a digital home or smart home device such as a home audio, video, and/or multimedia device, an appliance, a vending machine, intelligent lighting, a home security system, a smart meter, etc. A UE may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a UE may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., the UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a base station 108 may broadcast downlink traffic 112 to one or more UEs (e.g., a UE 106). Broadly, the base station 108 may be a node or device responsible for scheduling traffic in a wireless communication network, including the downlink traffic 112 and, in some examples, uplink traffic 116 and/or uplink control information 118 from one or more scheduled entities to the scheduling entity. In addition, the base station 108 may be a node or device that receives downlink control information 114, including but not limited to scheduling information (e.g., a grant), synchronization or timing information, or other control information from another entity in the wireless communication network such as the scheduling entity.

The uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry a certain number of OFDM symbols in some examples. A subframe may refer to a specified duration (e.g., 1 millisecond (ms)). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, each base station 108 may include a backhaul interface for communication with a backhaul 120 of the wireless communication system. The backhaul 120 may provide a link between a base station 108 and the core network 102. Further, in some examples, a backhaul network may provide interconnection between respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to an ETSI standard, a 3GPP standard, or any other suitable standard or configuration.

As mentioned above, the disclosure relates in some aspects to a UE that includes RFID reader functionality. RFID is used in a wide variety of applications including, for example, identification devices, inventory tracking, assembly line processes, access control, and so on.

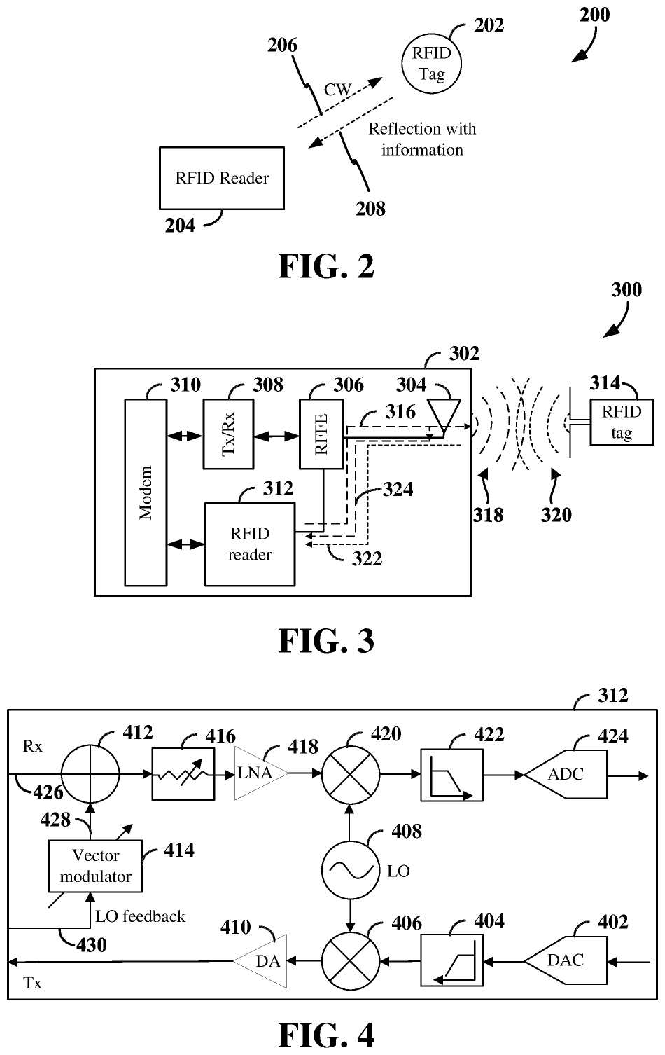

FIG. 2 illustrates an example RFID system 200 in accordance with another aspect of the disclosure. The RFID system 200 includes an RFID tag 202 and an RFID reader 204. In this example, the RFID tag 202 is a passive tag (e.g., it does not include its own power source) and uses a backscattering technique to send information to the RFID reader 204.

The RFID reader 204 transmits a CW RF signal 206 that can be received by the RFID tag 202 when the RFID tag 202 and the RFID reader 204 are relatively close to one another. In general, the operable distance is implementation specific. The RFID tag 202 uses the energy from the CW RF signal 206 to power a backscatter module (e.g., an energy reflecting and modulation circuit) and thereby modulate information on the CW RF signal. Thus, the RFID tag 202 transmits a reflected signal 208 that is modulated with the information. The RFID reader 204 includes circuitry to demodulate and decode the reflected signal 208 to recover the information sent by the RFID tag 202.

An RFID reader may be implemented in various types of devices. In some examples, an RFID reader may be implemented in a device that supports other forms of wireless communication.

FIG. 3 illustrates an example RFID system 300 including an apparatus 302 that incorporates RFID reader circuitry in accordance with another aspect of the disclosure. The apparatus 302 may be a UE or some other type of wireless communication device.

The apparatus 302 includes an antenna 304, an RF front end (RFFE) module 306, a transceiver 308, and a modem 310 that may be used for transmitting wireless communication signals to and receiving wireless communication signals from other wireless communication devices.

The apparatus 302 also includes dedicated RFID reader circuitry 312 that is used to read information from an RFID tag 314. The RFID reader circuitry 312 generates a CW signal 316 that is transmitted via the antenna 304 as an over-the-air CW RF signal 318. Responsive to the over-the-air CW RF signal 318, the RFID tag 314 outputs a modulated over-the-air signal 320 that carries information to be read by the RFID reader circuitry 312. The antenna 304 receives the over-the-air signal 320, whereby a corresponding modulated signal 322 (which may be referred to as the reflected signal) is provided to the RFID reader circuitry 312 via the RFFE module 306.

FIG. 4 illustrates an example of the RFID reader circuitry 312 of the apparatus 302 of FIG. 3 in accordance with another aspect of the disclosure. A transmit chain of the RFID reader circuitry 312 includes a digital-to-analog converter (DAC) 402 that converts information to be transmitted to an RFID tag (e.g., query information) to an analog signal. A filter 404 filters the analog signal to provide a filtered signal to a mixer 406. The mixer 406 upconverts the analog signal based on a signal from a local oscillator (LO) 408. An amplifier 410 amplifies the upconverted signal and provides an output signal to the RFFE module 306 of FIG. 3. A receive chain of the RFID reader circuitry 312 includes summer circuitry 412 that adds (or subtracts) the output of a vector modulator 414 to a received signal 426 (e.g., a reflected signal from the RFID tag 314 of FIG. 3 that was received at the RFFE module 306 via the antenna 304). A gain control circuit 416 adjusts the amplitude of the output of the summer circuitry 412. A low-noise amplifier (LNA) 418 amplifies the output of the gain control circuit 416. A mixer 420 down-converts the amplified signal based on a signal from the local oscillator 408. A low-pass filter 422 filters the down-converted signal and an analog-to-digital converter (ADC) 424 converts the analog filtered signal to a digital signal to enable further processing (e.g., decoding) of the received signal.

For a single antenna RFID reader, due to the limited isolation of a circulator or directional coupler, the CW signals transmitted by the RFID reader may leak to the receiver. These leaked signal may be referred to as a self-jamming signal. The frequency of the self-jamming signal is close to that of the useful reflected signal. Thus, it may be difficult to remove the self-jamming signal from the received signal using a filter.

As indicated in FIG. 3, the RFID reader circuitry 312 may receive a CW leakage signal 324 (self-jamming signal) associated with the CW signal 316 due to, for example, return loss of the antenna 304 and/or other factors. The amplitude of the CW leakage signal 324 may be higher than the amplitude of the modulated signal 322 (reflected signal) and thereby negatively impact the decoding of the modulated signal 322.

For example, in scenarios where the power of the self-jamming signal is much greater than the useful reflected signal received by the RFID reader, the useful reflected signal will be completely submerged in the self-jamming signal, resulting in receive (RX) saturation and sensitivity reduction. In this case, an RF front-end with a relatively high dynamic range may be employed to correctly distinguish the useful signals. The use of such an RF front-end may, however, increase the complexity and cost of the apparatus.

The backscattered signal may be an amplitude shift modulated (ASM) version of the CW RF signal transmitted from the RFID reader. In this case, since the frequencies of the transmitted and received signals are the same, the phase noise of the self-jamming signal may limit the receiver sensitivity. Consequently, the phase noise should be cancelled using a cancellation technique to improve the operating range of the RFID reader.

In some examples, the implementation of a single antenna RFID reader on an apparatus (e.g., a UE such as a cell phone) may involve the use of additional hardware to cancel the self-jamming signal to achieve long range targets (e.g., an RFID interrogation range greater than 10 cm). In the example of FIG. 4, the vector modulator 414 and the summer circuitry 412 are used to cancel the CW leakage signal 324 from the received signal 426 (which includes both the modulated signal 322 and the CW leakage signal 324). As shown, the vector modulator 414 generates a signal 428 (based on local oscillator feedback 430) that may be added to or subtracted from the received signal 426 to cancel some or all of the CW leakage signal 324.

The use of such dedicated RFID reader hardware (e.g., an RFID reader chip with a self-jamming signal canceller and an analog RF front end) may increase the bill of materials (BOM) cost of the apparatus. In addition, this RFID reader hardware may take up valuable space on the apparatus (e.g., which may be implemented on an integrated circuit).

The disclosure relates in some aspects to providing RFID technology on an apparatus (e.g., a UE such as a cell phone) without any additional hardware overhead. For example, the existing hardware of the apparatus that is used for wide area network (WAN) connectivity may be selectively repurposed to provide RFID functionality. In some examples (e.g., for previously deployed UEs), this may simply involve updating the software on the apparatus. Adding RFID reader functionality to an apparatus in this way may provide a low cost, highly integrated handheld solution that expands the industrial and consumer markets for such an apparatus. Moreover, this solution can be enabled on existing UEs with a software update, without any BOM cost.

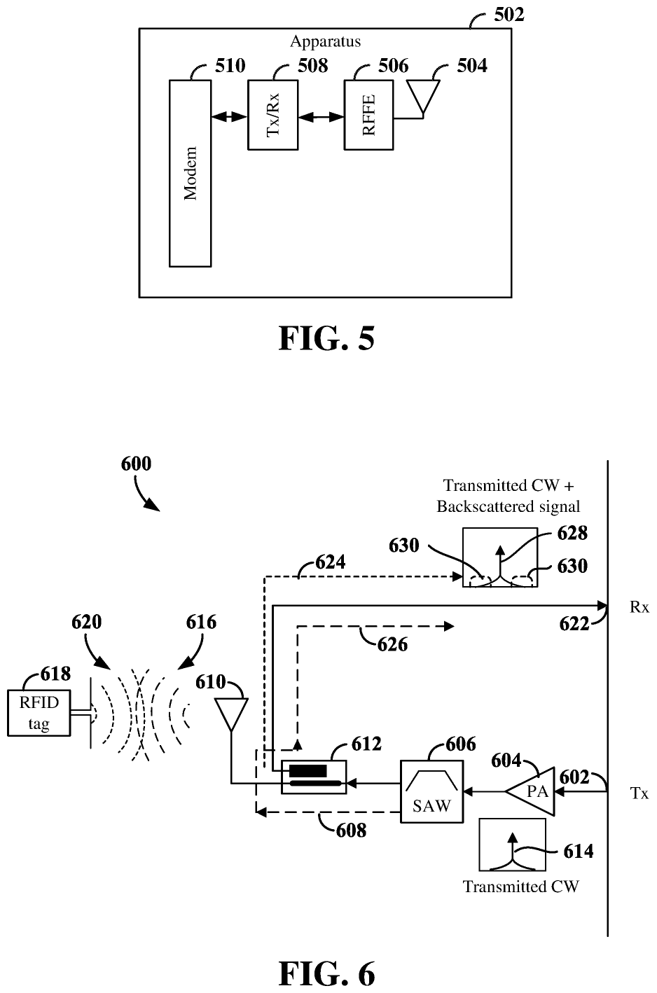

FIG. 5 illustrates a block diagram of an example apparatus 502 programmed to provide RFID reader functionality in accordance with another aspect of the disclosure. The apparatus 502 includes an antenna 504, an RF front end (RFFE) module 506, a transceiver 508, and a modem 510 that may be used for transmitting wireless communication signals to and receiving wireless communication signals from other wireless communication devices.

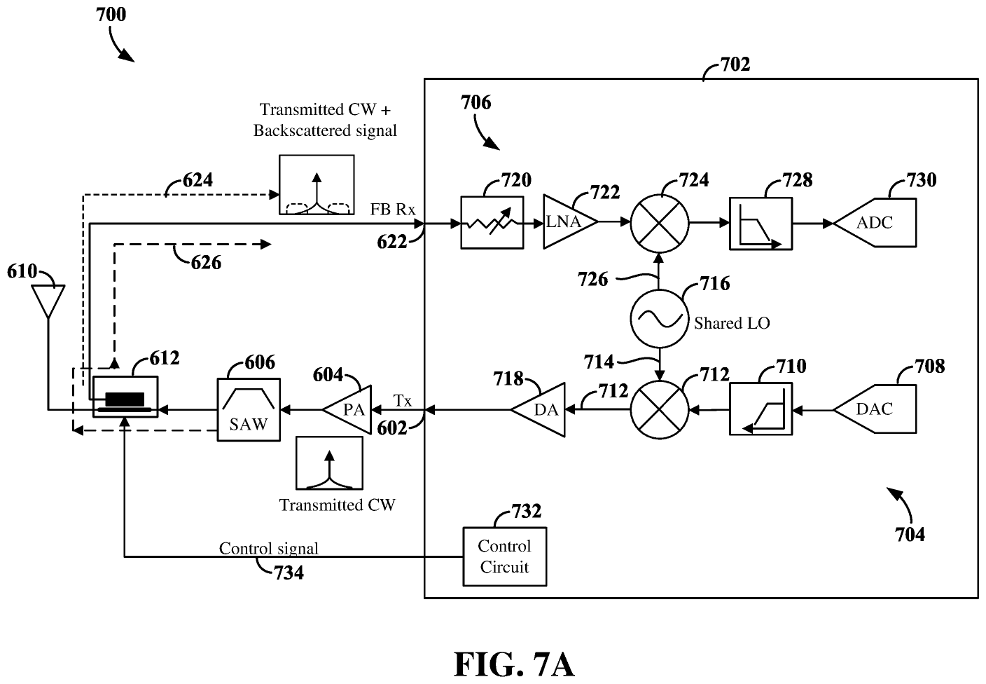

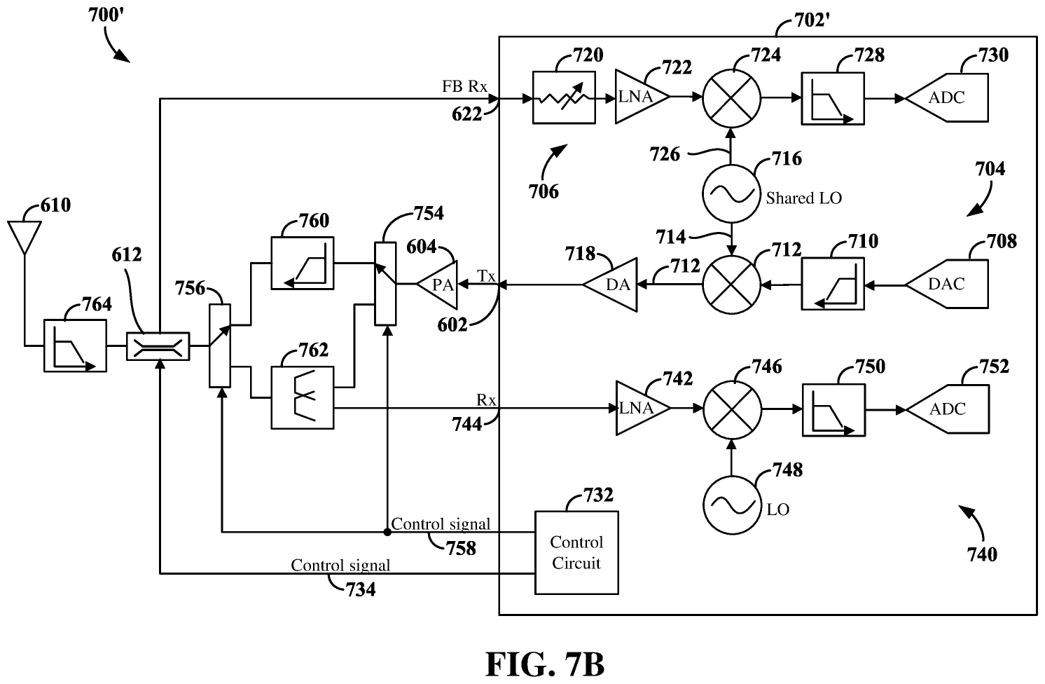

In addition, the apparatus 502 is programmed to provide RFID reader functionality that uses the existing hardware of the apparatus 502. For example, a transmit chain of the apparatus 502 is used generate a CW signal. In addition, a receive chain of the apparatus 502 is used to cancel a self-jamming signal component from a received signal, demodulate the resulting signal, and decode the information from an RFID tag embedded in the receive signal. These and other aspects of the apparatus 502 will be described in more detail below with reference to FIGS. 6 and 7.

FIG. 6 illustrates an example of circuitry 600 for transmitting a continuous wave (CW) signal and for receiving a reflected backscattered signal and a component of the transmitted CW signal in accordance with another aspect of the disclosure. The circuitry 600 may be implemented at the RF side of a transceiver (not explicitly shown in FIG. 6).

A CW signal from a Tx output 602 of the transceiver is amplified by a power amplifier 604 and filtered by a surface acoustic wave (SAW) filter 606. The resulting CW output signal 608 is coupled to an antenna 610 by directional coupler circuitry 612. A simplified representation of the frequency spectrum of the transmitted CW 614 is shown at the bottom of FIG. 6. FIG. 6 and other figures may, for purposes of clarity, depict the signals carried by a signal line (e.g., where the signal line is depicted as a solid line) as a dashed line that is drawn adjacent to the signal line.

The CW output signal 608 is transmitted via the antenna 610 as an over-the-air CW RF signal 616. Responsive to the over-the-air CW RF signal 616, an RFID tag 618 outputs a modulated over-the-air signal 620 (backscattered signal) that carries RFID information.

In this example, a single antenna (the antenna 610) is used to transmit the CW output signal 608 and to receive the modulated over-the-air signal 620 (backscattered signal). To enable the transceiver to receive this signal via the antenna 610, the directional coupler circuitry 612 is configured in a reverse mode (reverse coupled mode) whereby signals received from the antenna at the directional coupler circuitry 612 are coupled (subject to the reverse coupling factor of the directional coupler circuitry 612) to an Rx input 622 of the transceiver. Thus, the corresponding backscattered signal 624 is provided to Rx input 622 of the transceiver.

As discussed above, a CW leakage signal 626 associated with the CW output signal 608 may also be fed back to the Rx input 622 of the transceiver. For example, the CW leakage signal 626 may result from the return loss of the antenna 610 and/or less than perfect isolation of the directional coupler circuitry 612.

Thus, a composite signal may be received at the Rx input 622 that includes both the backscattered signal 624 and CW leakage signal 626. A simplified representation of the frequency spectrum of this composite signal is shown at the top of FIG. 6. As indicated, the composite signal includes frequency components 628 due to the CW leakage signal 626 and frequency components 630 due to the backscattered signal 624. Example operations of the transceiver relating to generating a CW signal and processing a corresponding received signal will be discussed with reference to FIG. 7A.

FIG. 7A illustrates a block diagram of an example apparatus 700 that provides RFID reader functionality in accordance with another aspect of the disclosure. In this example, the apparatus 700 includes the circuitry 600 of FIG. 6 and a transceiver 702. It should be appreciated that the components of the apparatus 700 may be implemented in different ways in different examples. For example, some of the components of the circuitry 600 may be implemented in the transceiver 702, or vice versa.

The transceiver 702 includes a transmit chain 704 and a receive chain 706. In some examples, the transceiver 702 may include other transmit and receive chains (not shown).

The transmit chain 704 includes a digital-to-analog converter (DAC) 708 that converts information to be transmitted to an RFID tag (e.g., query information) or other information to an analog signal. A filter 710 filters the analog signal to provide a filtered signal to a mixer 712. The mixer 712 upconverts the analog signal based on a signal 714 from a local oscillator 716. An amplifier 718 amplifies the upconverted signal and provides a CW signal to be transmitted (e.g., as discussed above in conjunction with FIG. 6).

The receive chain 706 includes a gain control circuit 720 that adjusts the amplitude of the received signal (e.g., the signal at the Rx input 622 discussed above in conjunction with FIG. 6). A low-noise amplifier (LNA) 722 amplifies the output of the gain control circuit 720. A mixer 724 down-converts the amplified signal based on a signal 726 from the local oscillator 716. Thus, in this example, the local oscillator 716 is shared by the transmit chain 704 and the receive chain 706. A low-pass filter 728 filters the down-converted signal and an analog-to-digital converter (ADC) 730 converts the analog filtered signal to a digital signal to enable further processing (e.g., decoding) of the received signal. For example, digital signal processing (not shown) may be capable of decoding an amplitude shift modulated (ASM) signal (or some other form of modulated signal) to extract RFID information from the signal.

A control circuit 732 may include functionality to control the coupling mode of the directional coupler circuitry 612. For example, when an RFID mode is invoked (e.g., a user of the apparatus activates an RFID application), the control circuit 732 may generate a control signal 734 that sets the directional coupler circuitry 612 to a reverse mode (reverse coupled mode). In some examples, the control circuit 732 may be implemented in a component other than the transceiver 702. For example, a processor of a UE that includes the transceiver 702 may implement some or all of the functionality of the control circuit 732.

As mentioned above, in the example of FIG. 7A, the transmit chain 704 and the receive chain 706 can be configured to use the same local oscillator for respective up-conversion and down-conversion operations. This configuration may assist in cancelling the phase noise of the received signal as follows.

Using the transmit (Tx) chain phase lock loop (PLL) (e.g., the local oscillator 716) for the receive chain implies that the phase noise will be the same for the transmit path and the receive path. The CW signal may be characterized by Equation 1 and the CW leakage signal at the input to the receive chain mixer (e.g., the mixer 724) may be represented by Equation 2.

$$A * {x}_{t} ( t ) * {e}^{j ( 2 * p i * {f}_{c} * t + {Φ}_{T x} ( t )} \qquad EQUATION 1$$

$$A * {x}_{t} ( t ) * {e}^{j ( 2 * p i * {f}_{c} * f + {Φ}_{T x} ( t ) + α )} \qquad EQUATION 2$$

Here, the parameter “A” is the scaling factor for the amplitude of the received signal, the parameter “Φ” is the phase noise, and the parameter “α” is the phase difference between the transmit path and the receive path. The LO signals at the mixer 712 and the mixer 724 may be characterized by Equations 3 and 4, respectively.

$${e}^{- j ( 2 * p i * {f}_{c} * t + α + {Φ}_{T x} ( t ) )} \qquad EQUATION 3$$

$${e}^{- j ( 2 * p i * {f}_{c} * t + α + {Φ}_{T x} ( t - τ ) )} \qquad EQUATION 4$$

Here, the parameter “τ” is the difference in delay between transmit and receive local oscillator (LO) path/routing (e.g., due to any differences in the paths associated with the signal 714 and the signal 726). In scenarios where the LO is shared and co-located with the transmit mixer and the receive mixer (e.g., located in the same area of an integrated circuit), the parameter “τ” will be very small. In this case:

$${Φ}_{T x} ( t ) \approx {Φ}_{T x} ( t - τ ) \qquad EQUATION 5$$

Consequently, the phase noise will be cancelled at the output the receive chain mixer (e.g., the mixer 724). This phase noise cancellation results in an increase in the signal-to-noise ratio (SNR) of the received signal (after the mixer 724) in the presence of strong self-jamming signal (at the Rx input 622).

The table below (broken up into Tables 1-4, for convenience) illustrates a simulated example of an interrogation range (e.g., maximum usable distance between an RFID reader and an RFID tag) that may be achieved using the RFID reader technology described herein. The table shows the range estimation of an RFID reader implemented without analog self-jamming signal cancellation (e.g., that uses a vector modulator). As indicated a range of approximately 50 centimeters may be achieved (e.g., on a UE such as a cell phone) without using dedicated RFID hardware.

The data of Tables 1-4 is based on the following assumptions. RFID links may be intrinsically unbalanced. Moreover, the reverse link may be highly correlated to the forward link because the RFID tag transmit power is determined by the RFID reader's transmit power. The link budget is given by the Equations 6 and 7, where Equation 6 is the Forward Link Maximum Allowable Loss and Equation 7 is the Reverse Link Maximum Allowable Loss.

$${L}_{f , max} = {P}_{tx} + {G}_{tx} + {G}_{tag} - K - {P}_{th} \qquad EQUATION 6$$

$${L}_{r , max} = ( {P}_{tx} + {G}_{tx} + 2 * {G}_{tag} + {G}_{r x} - Γ - N F - S N {R}_{{min}^{-}} {N}_{p n} - N ) / 2 \qquad EQUATION 7$$

In Equation 6, Pₜₓ(dBm)=the transmit signal power fed into the reader antenna; Gₜₓ (dBi)=the reader's transmit antenna gain; G_{tag} (dBi)=the tag antenna gain; K (dB)=the power loss due to backscatter modulation; and Pₜₕ (dBm)=the threshold power necessary to power up the chip.

In Equation 7, Γ (dB)=the power reflection loss; NF (dB)=the noise figure; SNRₘᵢₙ (dB)=the minimal SNR to meet a given performance; N (dBm)=the thermal noise power; and Nₚₙ (dBm)=the phase noise power of TX leakage.

TABLE 1
Reader CW Tx parameters

| | | |
|---|---|---|
| Tx power at antenna input | 29.00 | dBm |
| PAR of the Tx waveform | 3.00 | dB |
| Tx antenna gain | −5.00 | dBi |
| Tx LO phase noise | −115.00 | dBC/Hz |
| Coupler coupling factor | 25.00 | dB |
| Antenna return loss | 10.00 | dB |
| Channel frequency | 915.00 | MHz |

TABLE 2
Reader Rx parameters

| | | |
|---|---|---|
| SNR requirement | 12.00 | dB |
| Rx antenna gain | −5.00 | dBi |
| Signal bandwidth | 100.00 | KHz |
| Path loss | 2.00 | dB |
| Feedback (FB) Rx Gain | 9.00 | dB |
| NF referred to antenna | 61.30 | dB |
| Phase noise cancellation | 20.00 | dB |

TABLE 3
Tag parameters

| | | |
|---|---|---|
| Tag threshold | −20.00 | dBm |
| Tag antenna gain | −2.00 | dBi |
| Modulation index | 0.80 | |
| Power loss due to backscatter | 7.39 | dB |
| modulation | | |
| Power reflection loss | 1.94 | dB |

TABLE 4
Range calculation

| | | |
|---|---|---|
| Reverse link maximum allowable path | 25.45 | dB |
| loss | | |
| Reverse link maximum distance | 48.87 | CM |
| Forward link maximum allowable path | 34.61 | dB |
| loss | | |
| Forward link maximum distance | 140.33 | CM |
| Total interrogation range | 48.87 | CM |

FIG. 7B illustrates an apparatus 700′ corresponding to the apparatus 700 of FIG. 7A including additional wide area network (WAN) communication components in accordance with another aspect of the disclosure. The apparatus 700′ includes the components of FIG. 7A such as a transceiver 702′ (corresponding to the transceiver 702 of FIG. 7A) that includes the transmit chain 704 and the receive chain 706. In the example of FIG. 7B, the apparatus 700′ also includes a receive chain 740. It should be appreciated that the components of the apparatus 700′ may be implemented in different ways in different examples. For example, some of the components of the apparatus 700′ may be implemented in the transceiver 702′, or vice versa.

The receive chain 740 includes a low-noise amplifier (LNA) 742 that amplifies a received signal (e.g., a signal at a Rx input 744). A mixer 746 down-converts the amplified signal based on a signal from a local oscillator 748. A low-pass filter 750 filters the down-converted signal and an analog-to-digital converter (ADC) 752 converts the analog filtered signal to a digital signal to enable further processing (e.g., decoding) of the received signal.

When the apparatus 700′ is communicating with a WAN, the apparatus 700′ will use the transmit chain 704 for uplink transmission and the receive chain 740 for downlink reception. As shown in FIG. 7A, the apparatus 700′ includes a switch 754 and a switch 756 for selectively coupling the antenna 610 to the transmit chain 704 for transmit operations or to the receive chain 740 for receive operations. The control circuit 732 may include functionality to generate a control signal 758 for controlling the switch 754 and the switch 756. For example, during transmit operations, the control signal 758 may configure the switch 754 and the switch 756 so that they couple a signal output by the power amplifier 604 to the antenna 610 via the directional coupler circuitry 612. Conversely, during receive operations, the control signal 758 may configure the switch 754 and the switch 756 so that they couple a signal received by the antenna 610 and output by the directional coupler circuitry 612 to the Rx input 744.

FIG. 7B also illustrates various filters that may be used during transmit operations and/or receive operations. For example, a filter 760 may be used to filter signals output by the power amplifier 604. In addition, a filter 762 may be used to filter signals being provided to the Rx input 744. Also, a filter 764 may be used to both filter signals to be transmitted via the antenna 610 and filter signals received via the antenna 610.

As discussed above, the feedback (FB) Rx path (including the receive chain 706) may be used for RFID operations, digital pre-distortion (DPD) operations, Tx power measurements, antenna voltage standing wave ratio (VSWR) measurements, and so on. To support RFID operations in conjunction with WAN operations (e.g., on shared resources), the apparatus 700′ may be configured to tune away from WAN operations when an RFID operation needs to be performed. For example, a tune-away may occur when there is a conflict on and/or a limitation of a UE resource (e.g., RF hardware or modem hardware) among the radio access technologies (RATs) used for WAN operations and RFID operations. When there are resource conflicts among the RATs, some resources may be released based on one or more criteria (e.g., priority among the RATs). In some concurrency scenarios that involve a UE resource limitation or conflict (e.g., conflicting use of an antenna, receive chain paths, VCOs, etc.) one or more transmit chains and/or receive chains may be released or tuned away.

As one example of a tune away scenario, a WAN data call may be interrupted with artificial gaps. During each gap, the RF circuitry is tuned away to support activity on a different radio access technology (RAT). In some examples, a short tune away may be approximately 6 milliseconds (ms) up to 130 ms. In some examples, a long tune away may be as short as 10 ms, up to a few minutes or hours long (e.g., for voice calls). In some examples, an RFID read requires 10 mS to 200 mS depending on the number of TAG reads per second. Thus, an RFID operation can request a WAN tune away to repurpose the WAN hardware to do RFID operation. Then, once the measurement is complete (e.g., depending on a number of TAG reads per second requirement), the WAN hardware can be released to continue WAN operations. As another example, the RFID operation can request a WAN tune away to repurpose the WAN hardware to do the RFID operation for a specified period of time (e.g., depending on a number of TAG reads per second requirement).

In some examples, the circuitry of FIGS. 6 and 7 may be implemented in a UE that originally did not include RFID reader functionality. For example, this circuitry may be used for power control measurements for cellular (e.g., WAN) communication, voltage standing wave ratio (VSWR) measurements for cellular communication, or setting digital pre-distortion (DPD) parameters for cellular communication. In these scenarios, the directional coupler circuitry 612 may be configured in a forward mode whereby the directional coupler circuitry 612 couples a portion of an output signal back to the Rx input 622. For example, for power control and VSWR measurements, the receiver (not shown) may calculate the output transmit power based on the known coupling factor of the directional coupler circuitry 612 in the forward mode. The receiver may then adjust the transmit power accordingly and/or calculate the antenna VSWR. As another example, for DPD processing, a transmitted signal (which may be distorted by the output stages of the transmit chain) may be fed back to the receiver and used to adjust the DPD of the transmit chain. In some examples, the above functionality (e.g., a receive chain configured to operate with a single transmitter and directional coupler circuitry for measurement and DPD operations) may be referred to as a feedback receive (FB Rx) receiver.

In these examples, the UE may be configured to provide RFID reader functionality by programming the corresponding functionality into the UE. For example, a transmit chain of the transceiver may be programmed to selectively generate a CW signal when an RFID operation is invoked on the UE. In addition, a control circuit of the transceiver (or some other component of the UE) may be configured to generate a control signal to set the directional coupler circuitry to the reverse mode when an RFID operation is invoked on the UE. Also, a receive chain of the transceiver may be programmed to selectively cancel phase noise from a received signal (e.g., by coupling the mixer 724 to the local oscillator 716 instead of a dedicated receiver local oscillator) and to demodulate and decode the resulting signal to extract RFID information when an RFID operation is invoked on the UE.

An RFID reader as disclosed herein may be implemented in different ways in different examples. In some examples, the RFID reader may generate an ultra high frequency (UHF) CW signal. For example, the CW signal may be transmitted on a frequency band defined within a UHF spectrum (e.g., 300 MHz to 1 GHz). In some examples, the CW signal may be transmitted on a GSM band (e.g., band 5 or band 8).

The directional coupler circuitry may take different forms in different examples. In some examples, the directional coupler circuitry may include a bi-directional coupler (or a dual directional coupler) and a switch that selectively (e.g., under the control of a control signal) couples a couple forward output or a coupled reverse output of the coupler to the receive chain.

In some examples, the RFID reader may be implemented in an apparatus that includes a FB Rx receiver. In some examples, such an FB Rx receiver may be implemented within a transceiver (e.g., that includes one or more transmit chains and one or more receive chains). In some examples, such an FB Rx receiver may provide a relatively high dynamic range. For example, the FB Rx receiver may incorporate an ADC that has a relatively high sampling rate (e.g., up to 900 MHz).

In some examples, the transmit path uses a GSM power amplifier (e.g., for the power amplifier 604 of FIG. 6) to transmit the CW signal to an RFID tag. As discussed above, the directional coupler is configured in a reverse coupled mode which enables the same antenna to be used to transmit the CW signal and receive the backscattered signal from the RFID tag. In addition, the receive path may use an FB Rx receiver to down-convert and demodulate the backscattered signal. In some examples, such an FB Rx receiver is designed to handle a relatively high transmit (Tx) power coupled through the directional coupler. Depending on the Tx power level, the FB Rx gain can be adjusted to maximize the signal-to-noise ratio (SNR). Also, the FB Rx can be configured to re-use the Tx PLL. Consequently, the phase noise can be correlated and will, as a result, cancel, thereby leading to better receiver sensitivity.

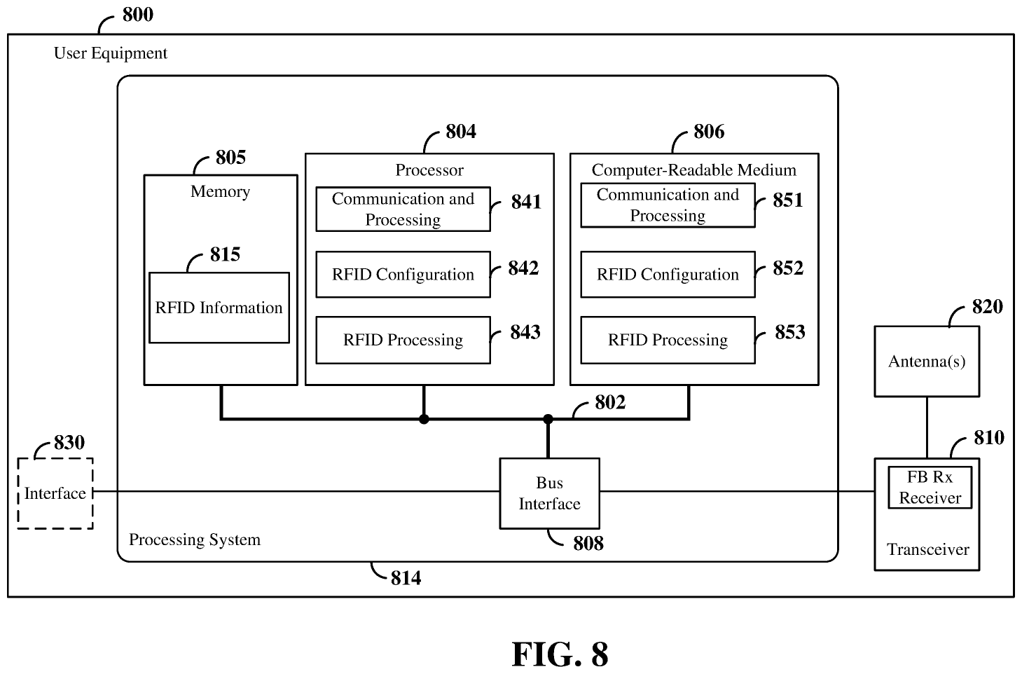

FIG. 8 illustrates a block diagram of an example user equipment 800 in accordance with another aspect of the disclosure. The user equipment 800 may be a device configured to wirelessly communicate in a network as discussed in FIG. 1. The user equipment 800 may correspond to any of the UEs described herein.

In accordance with various aspects of the disclosure, an element, or any portion of an element, or any combination of elements may be implemented with the processing system 814. The processing system 814 may include one or more processors (referred to herein as the processor 804, for convenience). Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the user equipment 800 may be configured to perform any one or more of the functions described herein. That is, the processor 804, as utilized in an user equipment 800, may be used to implement any one or more of the processes and procedures described herein.

The processor 804 may in some instances be implemented via a baseband or modem chip and in other implementations, the processor 804 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits including one or more processors (represented generally by the processor 804), one or more memories (referred to herein as the memory 805, for convenience), and one or more computer-readable media (represented generally by the computer-readable medium 806). The bus 802 may also link various other circuits such as timing sources, peripherals, voltage regulators, and power management circuits, which are well known in the art, and therefore, will not be described any further. A bus interface 808 provides an interface between the bus 802, a transceiver 810 and an antenna array 820 and between the bus 802 and an interface 830. The transceiver 810 provides a communication interface or means for communicating with various other apparatus over a wireless transmission medium. The interface 830 provides a communication interface or means of communicating with various other apparatuses and devices (e.g., other devices housed within the same apparatus as the user equipment 800 or other external apparatuses) over an internal bus or external transmission medium, such as an Ethernet cable. Depending upon the nature of the apparatus, the interface 830 may include a user interface (e.g., keypad, display, speaker, microphone, joystick). Of course, such a user interface is optional, and may be omitted in some examples, such as an IoT device.

The processor 804 is responsible for managing the bus 802 and general processing, including the execution of software stored on the computer-readable medium 806. The software, when executed by the processor 804, causes the processing system 814 to perform the various functions described below for any particular apparatus. The computer-readable medium 806 and the memory 805 may also be used for storing data that is manipulated by the processor 804 when executing software. For example, the memory 805 may store RFID information 815 (e.g., RFID parameters) used by the processor 804 for the communication operations described herein.

One or more processors 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 806.

The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may reside in the processing system 814, external to the processing system 814, or distributed across multiple entities including the processing system 814. The computer-readable medium 806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

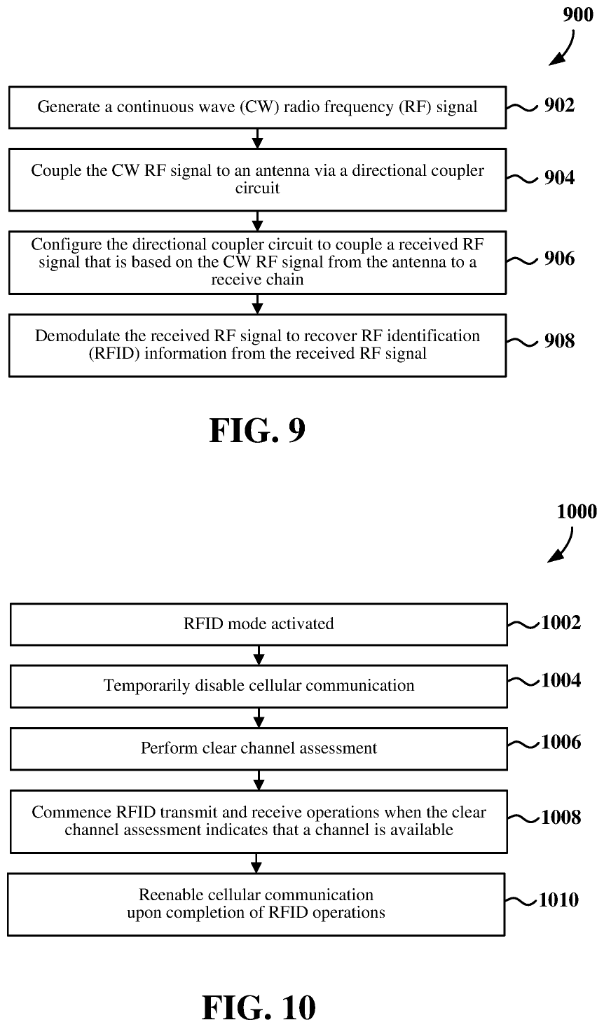

The user equipment 800 may be configured to perform one or more of the operations described herein (e.g., as described above in conjunction with FIGS. 1-7 and as described below in conjunction with FIGS. 9 and 10). In some aspects of the disclosure, the processor 804, as utilized in the user equipment 800, may include circuitry configured for various functions.

In some aspects of the disclosure, the processor 804 may include communication and processing circuitry 841. The communication and processing circuitry 841 may be configured to communicate with a base station. The communication and processing circuitry 841 may include one or more hardware components that provide the physical structure that performs various processes related to communication (e.g., signal reception and/or signal transmission) as described herein. The communication and processing circuitry 841 may further include one or more hardware components that provide the physical structure that performs various processes related to signal processing (e.g., processing a received signal and/or processing a signal for transmission) as described herein. The communication and processing circuitry 841 may further be configured to execute communication and processing software 851 included on the computer-readable medium 806 to implement one or more functions described herein.

In some implementations where the communication involves receiving information, the communication and processing circuitry 841 may obtain information from a component of the user equipment 800 (e.g., from the transceiver 810 that receives the information via radio frequency signaling or some other type of signaling suitable for the applicable communication medium), process (e.g., decode) the information, and output the processed information. For example, the communication and processing circuitry 841 may output the information to another component of the processor 804, to the memory 805, or to the bus interface 808. In some examples, the communication and processing circuitry 841 may receive one or more of signals, messages, other information, or any combination thereof. In some examples, the communication and processing circuitry 841 may receive information via one or more channels. In some examples, the communication and processing circuitry 841 may receive one or more of signals, messages, SCIs, feedback, other information, or any combination thereof. In some examples, the communication and processing circuitry 841 and/or the transceiver 810 may include functionality for a means for receiving. In some examples, the communication and processing circuitry 841 may include functionality for a means for decoding. In some examples, the communication and processing circuitry 841 may include functionality for a means for receiving information from a network entity.

In some implementations where the communication involves sending (e.g., transmitting) information, the communication and processing circuitry 841 may obtain information (e.g., from another component of the processor 804, the memory 805, or the bus interface 808), process (e.g., encode) the information, and output the processed information. For example, the communication and processing circuitry 841 may output the information to the transceiver 810 (e.g., that transmits the information via radio frequency signaling or some other type of signaling suitable for the applicable communication medium). In some examples, the communication and processing circuitry 841 may send one or more of signals, messages, other information, or any combination thereof. In some examples, the communication and processing circuitry 841 may send information via one or more channels. In some examples, the communication and processing circuitry 841 may send one or more of signals, messages, SCIs, feedback, other information, or any combination thereof. In some examples, the communication and processing circuitry 841 and/or the transceiver 810 may include functionality for a means for transmitting. In some examples, the communication and processing circuitry 841 may include functionality for a means for encoding. In some examples, the communication and processing circuitry 841 may include functionality for a means for transmitting information to a network entity.

The processor 804 may include RFID configuration circuitry 842 configured to perform RFID configuration-related operations as discussed herein. The RFID configuration circuitry 842 may be configured to execute RFID configuration software 852 included on the computer-readable medium 806 to implement one or more functions described herein.

The RFID configuration circuitry 842 may include functionality for a means for configuring a transmit chain and/or a receive chain. For example, responsive to the invocation of an RFID application (e.g., by a user of the user equipment 800), the RFID configuration circuitry 842 may configure a transmit chain to generate a CW signal and configure a receive chain to use the same local oscillator as the transmit chain.

The RFID configuration circuitry 842 may include functionality for a means for configuring a directional coupler. For example, responsive to the invocation of an RFID application (e.g., by a user of the user equipment 800), the RFID configuration circuitry 842 may generate a control signal to configure a directional coupler circuit in a reverse mode.

The RFID configuration circuitry 842 may include functionality for a means for temporarily disabling or enabling communication. For example, responsive to the invocation of an RFID application (e.g., by a user of the user equipment 800), the RFID configuration circuitry 842 may temporarily disable cellular communication (e.g., WAN transmissions). As another example, responsive to the end of an RFID process (e.g., a successful read of an RFID tag), the RFID configuration circuitry 842 may reenable cellular communication (e.g., WAN transmissions).

The processor 804 may include RFID processing circuitry 843 configured to perform RFID processing-related operations as discussed herein. The RFID processing circuitry 843 may be configured to execute RFID processing software 853 included on the computer-readable medium 806 to implement one or more functions described herein.

The RFID processing circuitry 843 may include functionality for a means for performing a RFID processing operation. For example, the RFID processing circuitry 843 may include functionality for a means for demodulating and/or decoding. As an example, the RFID processing circuitry 843 may demodulate and/or decode a received signal to recover RFID information (e.g., any type information sent from an RFID tag) from the signal.

The RFID processing circuitry 843 may include functionality for a means for performing a clear channel assessment (CCA). For example, the RFID processing circuitry 843 may cooperate with the communication and processing circuitry 841 and the transceiver 810 to monitor a particular frequency band and determine whether any energy detected on the frequency band exceeds a CCA threshold.

The RFID processing circuitry 843 may include functionality for a means for commencing RFID operations. For example, the RFID processing circuitry 843 may commence RFID transmit and receive operations when the CCA indicates that a channel is available.

FIG. 9 illustrates a flow diagram of an example RFID method in accordance with another aspect of the disclosure. As described below, some or all illustrated features may be omitted in a particular implementation within the scope of the present disclosure, and some illustrated features may not be required for implementation of all examples. In some examples, the method 900 (e.g., a method for wireless communication) may be carried out by the user equipment 800 illustrated in FIG. 8, or another wireless communication device. In some examples, the method 900 may be carried out by any suitable apparatus or means for carrying out the functions or algorithm described herein.

At block 902, an apparatus (e.g., the user equipment 800 or another apparatus) may generate a continuous wave (CW) radio frequency (RF) signal. Example means for generating a CW RF signal may include any of the transmit chains, transmitters, transceivers, or related circuitry described herein. For example, the RFID configuration circuitry 842 may configure a transmit chain to generate a CW signal.

At block 904, the apparatus may couple the CW RF signal to an antenna via a directional coupler circuit. Example means for coupling the CW RF signal to an antenna via a directional coupler circuit may include any of the transmit chains, transmit paths, RFFEs, RF circuitry, or related circuitry described herein. For example, the RFID configuration circuitry 842 may configure a transmit chain to couple its output (e.g., via a switch) to a directional coupler circuit. As another example, a transmit chain may be directly connected to a directional coupler circuit so that the CW RF signal is coupled to an antenna via a directional coupler circuit.

At block 906, the apparatus may configure the directional coupler circuit to couple a received RF signal that is based on the CW RF signal from the antenna to a receive chain. Example means for configuring the directional coupler circuit to couple a received RF signal that is based on the CW RF signal from the antenna to a receive chain may include any of the control circuits, transmit chains, transmit paths, transceivers, processors, or related circuitry described herein. For example, the RFID configuration circuitry 842 may generate a control signal to configure a directional coupler circuit in a reverse mode. As another example, a control circuit of the apparatus may generate a control signal to configure a directional coupler circuit in a reverse mode.

At block 908, the apparatus may demodulate the received RF signal to recover RF identification (RFID) information from the received RF signal. Example means for demodulating the received RF signal to recover RF identification (RFID) information from the received RF signal may include any of the receive chains, transceivers, processors, or related circuitry described herein. For example, the RFID processing circuitry 843 may demodulate a received signal to recover RFID information from the signal. As another example, a transceiver of the apparatus may demodulate a received signal to recover RFID information from the signal.

In some examples, the apparatus may generate a control signal to configure the directional coupler circuit in a reverse mode for an RFID mode of operation. In some examples, the apparatus may generate the control signal to configure the directional coupler circuit in a forward mode for a power control measurement mode of operation for cellular (e.g., WAN) communication or a voltage standing wave ratio (VSWR) measurement mode of operation for cellular communication.

In some examples, the received RF signal may include an amplitude shift modulated reflection of the CW RF signal. In some examples, the apparatus may perform an amplitude shift demodulation of the received RF signal.

In some examples, the received RF signal may include a first component and a second component. In some examples, the first component may include phase noise due to leakage of the CW RF signal at the receive chain. In some examples, the second component may include an amplitude shift modulated signal based on the CW RF signal. In some examples, the apparatus may subtract the first component from the received RF signal and recover the RFID information from the amplitude shift modulated signal.

In some examples, the apparatus may generate the CW RF signal from a local oscillator signal. In some examples, the apparatus may down-convert the received RF signal using the local oscillator signal. In some examples, the apparatus may multiply the local oscillator signal and the received RF signal to recover the RFID information.

In some examples, the apparatus may selectively configure a transmit chain and the receive chain to operate in a first mode of operation associated with RFID communication or in a second mode of operation associated with cellular communication. In some examples, the apparatus may, in the first mode of operation associated with RFID communication, configure the transmit chain to generate the CW RF signal. In some examples, the apparatus may, in the second mode of operation associated with cellular communication, configure the transmit chain to generate first information signals destined for a network entity of a wireless communication network. In some examples, the apparatus may, in the first mode of operation associated with RFID communication, configure the receive chain to demodulate the received RF signal to recover the RFID information. In some examples, the apparatus may, in the second mode of operation associated with cellular communication, configure the receive chain (or another receive chain) to receive second information signals from the network entity.

In some examples, the apparatus may configure the receive chain to perform a clear channel assessment (CCA) procedure on an RF channel. In some examples, the apparatus may configure the transmit chain to transmit the CW RF signal responsive to the CCA procedure indicating that the RF channel is available for use.

In some examples, the apparatus may generate the CW RF signal for transmission on an ultra high frequency (UHF) band. In some examples, the apparatus may monitor the UHF band for the received RF signal. In some examples, the UHF band may include a global system for mobile communications (GSM) band. In some examples, the UHF band may include a frequency range from 800 megahertz (MHz) to 1 gigahertz (GHz).

FIG. 10 illustrates a flow diagram of another example RFID method in accordance with another aspect of the disclosure. As described below, some or all illustrated features may be omitted in a particular implementation within the scope of the present disclosure, and some illustrated features may not be required for implementation of all examples. In some examples, the method 1000 (e.g., a method for wireless communication) may be carried out by the user equipment 800 illustrated in FIG. 8, or another wireless communication device. In some examples, the method 1000 may be carried out by any suitable apparatus or means for carrying out the functions or algorithm described herein.

At block 1002, an apparatus (e.g., the user equipment 800 or another apparatus) may activate an RFID mode. Example means for activating an RFID mode may include any of the processors or related circuitry described herein. For example, the RFID processing circuitry 843 may provide an application that enables a user of the apparatus to activate an RFID mode.

At block 1004, the apparatus temporarily disables cellular (e.g., WAN) communication. Example means for temporarily disabling cellular communication may include any of the processors or related circuitry described herein. For example, in response to the activation of the RFID mode, the RFID configuration circuitry 842 may temporarily disable cellular communication (e.g., GSM transmissions). In certain scenarios, the apparatus may be able to support concurrent operation of WAN and RFID by sharing the resources. For example, a WAN operating in higher frequency bands can concurrently operate with RFID. When the WAN requires the feedback receive path to do transmit (Tx) measurements, the RFID operation can be halted for that time duration and resumed later once the WAN completes its required measurements through the feedback receive path.

At block 1006, the apparatus may perform a clear channel assessment. Example means for performing a clear channel assessment may include any of the receive chains, transceivers, processors, or related circuitry described herein. For example, the RFID processing circuitry 843 may cooperate with the communication and processing circuitry 841 and the transceiver 810 to monitor a particular frequency band and determine whether any energy detected on the frequency band exceeds a CCA threshold.

At block 1008, the apparatus may commence RFID transmit and receive operations when the clear channel assessment indicates that a channel is available. Example means for commencing RFID transmit and receive operations may include any of the processors or related circuitry described herein. For example, the RFID configuration circuitry 842 and/or the RFID processing circuitry 843 may commence RFID transmit and receive operations when the CCA indicates that a channel is available.

At block 1010, the apparatus reenables cellular communication upon completion of RFID operations. Example means for reenabling cellular communication upon completion of RFID operations may include any of the processors or related circuitry described herein. For example, responsive to the end of an RFID process (e.g., a successful read of an RFID tag), the RFID configuration circuitry 842 may reenable cellular communication (e.g., GSM transmissions).

Referring again to FIG. 8, in one configuration, the user equipment 800 includes means for generating a continuous wave (CW) radio frequency (RF) signal, directional coupler means for coupling the CW RF signal to an antenna, means for configuring the directional coupler means to couple a received RF signal that is based on the CW RF signal from the antenna to a means for receiving, and means for demodulating the received RF signal to recover RF identification (RFID) information from the received RF signal. In one aspect, the aforementioned means may be the processor 804 shown in FIG. 8 configured to perform the functions recited by the aforementioned means (e.g., as discussed above). In another aspect, the aforementioned means may be a circuit or any apparatus configured to perform the functions recited by the aforementioned means (e.g., as described herein in conjunction with FIGS. 1-7, 9, and 10).

The following provides an overview of aspects of the present disclosure:

Aspect 1: An apparatus, comprising: a receive chain; a transmit chain configured to generate a continuous wave (CW) radio frequency (RF) signal; and a directional coupler circuit configured to couple the CW RF signal to an antenna, the directional coupler circuit being configurable to couple a received RF signal that is based on the CW RF signal from the antenna to the receive chain; the receive chain being configured to demodulate the received RF signal to recover RF identification (RFID) information from the received RF signal.

Aspect 2: The apparatus of aspect 1, further comprising: a control circuit configured to output a control signal to configure the directional coupler circuit in a reverse mode for an RFID mode of operation.

Aspect 3: The apparatus of aspect 2, wherein the control circuit is further configured to output the control signal to configure the directional coupler circuit in a forward mode for a power control measurement mode of operation for cellular communication or a voltage standing wave ratio (VSWR) measurement mode of operation for cellular communication.

Aspect 4: The apparatus of any one of aspects 1-3, wherein: the received RF signal comprises an amplitude shift modulated reflection of the CW RF signal; and the receive chain is further configured to perform an amplitude shift demodulation of the received RF signal.

Aspect 5: The apparatus of any one of aspects 1-4, wherein: the received RF signal comprises a first component and a second component; the first component comprises phase noise due to leakage of the CW RF signal at the receive chain; the second component comprises an amplitude shift modulated signal based on the CW RF signal; and the receive chain is further configured to subtract the first component from the received RF signal and recover the RFID information from the amplitude shift modulated signal.

Aspect 6: The apparatus of any one of aspects 1-5, further comprising a local oscillator, wherein: a first mixer of the transmit chain generates the CW RF signal from a first signal output by the local oscillator; and a second mixer of the receive chain down-converts the received RF signal using the first signal output by the local oscillator.

Aspect 7: The apparatus of aspect 6, wherein the receive chain is further configured to: multiply the first signal output by the local oscillator and the received RF signal to recover the RFID information.

Aspect 8: The apparatus of any one of aspects 6-7, wherein the local oscillator, the transmit chain, and the receive chain are co-located on an integrated circuit.

Aspect 9: The apparatus of any one of aspects 1-8, further comprising: a control circuit configured to selectively configure the transmit chain and the receive chain to operate in a first mode of operation associated with RFID communication or in a second mode of operation associated with cellular communication.

Aspect 10: The apparatus of aspect 9, wherein: in the first mode of operation associated with RFID communication, the transmit chain is further configured to generate the CW RF signal; in the second mode of operation associated with cellular communication, the transmit chain is further configured to generate first information signals destined for a network entity of a wireless communication network; in the first mode of operation associated with RFID communication, the receive chain is further configured to demodulate the received RF signal to recover the RFID information; and in the second mode of operation associated with cellular communication, another receive chain is configured to receive second information signals from the network entity.

Aspect 11: The apparatus of any one of aspects 1-10, further comprising a control circuit configured to: configure the receive chain to perform a clear channel assessment (CCA) procedure on an RF channel; and configure the transmit chain to transmit the CW RF signal responsive to the CCA procedure indicating that the RF channel is available for use.

Aspect 12: The apparatus of any one of aspects 1-11, wherein: the transmit chain is further configured to generate the CW RF signal for transmission on an ultra high frequency (UHF) band; and the receive chain is further configured to monitor the UHF band for the received RF signal.

Aspect 13: The apparatus of aspect 12, wherein the UHF band comprises a global system for mobile communications (GSM) band.

Aspect 14: The apparatus of aspect 12, wherein the UHF band comprises a frequency range from 800 megahertz (MHz) to 1 gigahertz (GHz).

Aspect 15: The apparatus of any one of aspects 1-14, wherein the apparatus comprises a feedback receive (FB Rx) receiver including the receive chain.

Aspect 16: The apparatus of any one of aspects 1-15, wherein the apparatus is configured as a user equipment for cellular communication.

Aspect 17: A method, comprising: generating a continuous wave (CW) radio frequency (RF) signal; coupling the CW RF signal to an antenna via a directional coupler circuit; configuring the directional coupler circuit to couple a received RF signal that is based on the CW RF signal from the antenna to a receive chain; and demodulating the received RF signal to recover RF identification (RFID) information from the received RF signal.

Aspect 18: The method of aspect 17, further comprising: generating a control signal to configure the directional coupler circuit in a reverse mode for an RFID mode of operation.

Aspect 19: The method of aspect 18, further comprising: generating the control signal to configure the directional coupler circuit in a forward mode for a power control measurement mode of operation for cellular communication or a voltage standing wave ratio (VSWR) measurement mode of operation for cellular communication.

Aspect 20: The method of any one of aspects 17-19, wherein: the received RF signal comprises an amplitude shift modulated reflection of the CW RF signal; and the method further comprises performing an amplitude shift demodulation of the received RF signal.

Aspect 21: The method of aspect 20, wherein: the received RF signal comprises a first component and a second component; the first component comprises phase noise due to leakage of the CW RF signal at the receive chain; the second component comprises an amplitude shift modulated signal based on the CW RF signal; and the method further comprises subtracting the first component from the received RF signal and recover the RFID information from the amplitude shift modulated signal.

Aspect 22: The method of any one of aspects 17-21, further comprising: generating the CW RF signal from a local oscillator signal; and down-converting the received RF signal using the local oscillator signal.

Aspect 23: The method of aspect 22, further comprising: multiplying the local oscillator signal and the received RF signal to recover the RFID information.

Aspect 24: The method of any one of aspects 17-23, further comprising: selectively configuring a transmit chain and the receive chain to operate in a first mode of operation associated with RFID communication or in a second mode of operation associated with cellular communication.

Aspect 25: The method of aspect 24, further comprising: in the first mode of operation associated with RFID communication, configuring the transmit chain to generate the CW RF signal; in the second mode of operation associated with cellular communication, configuring the transmit chain to generate first information signals destined for a network entity of a wireless communication network; in the first mode of operation associated with RFID communication, configuring the receive chain to demodulate the received RF signal to recover the RFID information; and in the second mode of operation associated with cellular communication, configuring the receive chain to receive second information signals from the network entity.

Aspect 26: The method of any one of aspects 17-25, further comprising: configuring the receive chain to perform a clear channel assessment (CCA) procedure on an RF channel; and configuring the transmit chain to transmit the CW RF signal responsive to the CCA procedure indicating that the RF channel is available for use.

Aspect 27: The method of any one of aspects 17-26, further comprising: generating the CW RF signal for transmission on an ultra high frequency (UHF) band; and monitoring the UHF band for the received RF signal.

Aspect 28: The method of aspect 27, wherein the UHF band comprises a global system for mobile communications (GSM) band.

Aspect 29: The method of aspect 27, wherein the UHF band comprises a frequency range from 800 megahertz (MHz) to 1 gigahertz (GHz).

Aspect 30: An apparatus, comprising: means for generating a continuous wave (CW) radio frequency (RF) signal; directional coupler means for coupling the CW RF signal to an antenna; means for configuring the directional coupler means to couple a received RF signal that is based on the CW RF signal from the antenna to a means for receiving; and means for demodulating the received RF signal to recover RF identification (RFID) information from the received RF signal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a receive chain;
a transmit chain configured to generate a continuous wave (CW) radio frequency (RF) signal; and
a directional coupler circuit configured to couple the CW RF signal to an antenna, the directional coupler circuit being configurable to couple a received RF signal that is based on the CW RF signal from the antenna to the receive chain;
the receive chain being configured to demodulate the received RF signal to recover RF identification (RFID) information from the received RF signal.

2. The apparatus of claim 1, further comprising:
a control circuit configured to output a control signal to configure the directional coupler circuit in a reverse mode for an RFID mode of operation.

3. The apparatus of claim 2, wherein the control circuit is further configured to output the control signal to configure the directional coupler circuit in a forward mode for a power control measurement mode of operation for cellular communication or a voltage standing wave ratio (VSWR) measurement mode of operation for cellular communication.

4. The apparatus of claim 1, wherein:
the received RF signal comprises an amplitude shift modulated reflection of the CW RF signal; and
the receive chain is further configured to perform an amplitude shift demodulation of the received RF signal.

5. The apparatus of claim 1, wherein:
the received RF signal comprises a first component and a second component;
the first component comprises phase noise due to leakage of the CW RF signal at the receive chain;
the second component comprises an amplitude shift modulated signal based on the CW RF signal; and
the receive chain is further configured to subtract the first component from the received RF signal and recover the RFID information from the amplitude shift modulated signal.

6. The apparatus of claim 1, further comprising a local oscillator, wherein:
a first mixer of the transmit chain generates the CW RF signal from a first signal output by the local oscillator; and
a second mixer of the receive chain down-converts the received RF signal using the first signal output by the local oscillator.

7. The apparatus of claim 6, wherein the receive chain is further configured to:
multiply the first signal output by the local oscillator and the received RF signal to recover the RFID information.

8. The apparatus of claim 6, wherein the local oscillator, the transmit chain, and the receive chain are co-located on an integrated circuit.

9. The apparatus of claim 1, further comprising:
a control circuit configured to selectively configure the transmit chain and the receive chain to operate in a first mode of operation associated with RFID communication or in a second mode of operation associated with cellular communication.

10. The apparatus of claim 9, wherein:
in the first mode of operation associated with RFID communication, the transmit chain is further configured to generate the CW RF signal;
in the second mode of operation associated with cellular communication, the transmit chain is further configured to generate first information signals destined for a network entity of a wireless communication network;
in the first mode of operation associated with RFID communication, the receive chain is further configured to demodulate the received RF signal to recover the RFID information; and
in the second mode of operation associated with cellular communication, another receive chain is configured to receive second information signals from the network entity.

11. The apparatus of claim 1, further comprising a control circuit configured to:
configure the receive chain to perform a clear channel assessment (CCA) procedure on an RF channel; and
configure the transmit chain to transmit the CW RF signal responsive to the CCA procedure indicating that the RF channel is available for use.

12. The apparatus of claim 1, wherein:
the transmit chain is further configured to generate the CW RF signal for transmission on an ultra high frequency (UHF) band; and
the receive chain is further configured to monitor the UHF band for the received RF signal.

13. The apparatus of claim 12, wherein the UHF band comprises at least one of:
a global system for mobile communications (GSM) band; or
a frequency range from 800 megahertz (MHz) to 1 gigahertz (GHz).

14. The apparatus of claim 1, wherein the apparatus comprises a feedback receive (FB Rx) receiver including the receive chain.

15. The apparatus of claim 1, wherein the apparatus is configured as a user equipment for cellular communication.

16. A method, comprising:
generating a continuous wave (CW) radio frequency (RF) signal;
coupling the CW RF signal to an antenna via a directional coupler circuit;
configuring the directional coupler circuit to couple a received RF signal that is based on the CW RF signal from the antenna to a receive chain; and
demodulating the received RF signal to recover RF identification (RFID) information from the received RF signal.

17. The method of claim 16, further comprising:
generating a control signal to configure the directional coupler circuit in a reverse mode for an RFID mode of operation.

18. The method of claim 17, further comprising:
generating the control signal to configure the directional coupler circuit in a forward mode for a power control measurement mode of operation for cellular communication or a voltage standing wave ratio (VSWR) measurement mode of operation for cellular communication.

19. The method of claim 17, further comprising:
selectively configuring a transmit chain and the receive chain to operate in a first mode of operation associated with RFID communication or in a second mode of operation associated with cellular communication.

20. An apparatus, comprising:
means for generating a continuous wave (CW) radio frequency (RF) signal;
directional coupler means for coupling the CW RF signal to an antenna;
means for configuring the directional coupler means to couple a received RF signal that is based on the CW RF signal from the antenna to a means for receiving; and
means for demodulating the received RF signal to recover RF identification (RFID) information from the received RF signal.
